(19) United States
(12) Patent Application Publication
(10) Pub. No.: US 2012/0139240 A1
(43) Pub. Date: Jun. 7, 2012

(54) METHOD FOR REDUCING LOADS IN A WIND TURBINE

(76) Inventors: Diego Otamendi Claramunt, Pamplona (ES); Emilio Escalante Arroyo, Navarra (ES); Gema Rodriguez Parro, Navarra (ES); Francisco Javier Echarte Casquero, Navarra (ES)

(21) Appl. No.: 12/515,024

(22) PCT Filed: Nov. 13, 2007
(86) PCT No.: PCT/ES2007/000649

§ 371 Date: Nov. 30, 2009

(30) Foreign Application Priority Data
Nov. 17, 2006 (ES) ES200602931

(51) Int. Cl. H02P 9/04

(52) U.S. Cl. 290/44

(57) ABSTRACT

Loads reduction method in a wind turbine for power-grid disconnection during a wind gust, which uses a control system made up of three loops used to correct the speed at which the wind turbine blades are moved to the feathered position throughout a controlled emergency stop, with a non-linear law that takes into account blade position, tower vibrations and generator rotation speed limits.

### OBJECT OF THE INVENTION

The present invention refers to a loads reduction method in a wind turbine and specially, to a loads reduction method in a wind turbine during a controlled emergency stop when a power-grid disconnection is combined during the action of a wind gust. The loads reduction method is based on adjusting the speed at which the wind turbine blades are moved into the featured position.

### BACKGROUND OF THE INVENTION

Variable speed wind turbines with control means for blades pitch change are well known in the state-of-the-art. These control means generally include at least a pitch change motor and a transmission, connected to control devices that receive data from the wind turbine's components and send signals to the pitch change motor to rotate the blade around its longitudinal shaft according to some strategies that allow to optimize the produced power and at the same time to protect the wind turbine itself in the cases of wind gusts or emergencies.

In the case of extreme wind gusts and/or emergencies such as the disconnection of the generator from the power-grid, the malfunction of any of its components, etc., the known state-of-the-art contemplates control systems to stop the wind turbine taking the blades to feathered position as quickly as possible, and therefore emergency stops, even though often very short, are uncontrolled and harmful for some of the wind turbine's components.

The following documents show a wide range of techniques and methods used in the state-of-the-art to reduce loads or vibration, sometimes occurring during operation in normal wind turbine conditions, and in others, during emergency stops:

Application WO2005083266, contemplates a method for insulating vibrations in the nacelle and tower of a wind turbine in normal operating conditions, based on measuring nacelle acceleration with accelerometers fixed to it, and the subsequent processing for calculating the blade angle used to obtain the necessary wind thrust to cancel these vibrations.

Publication WO06007838, refers to a linear wind turbine blade feathering system with two speeds during an emergency stop caused by a wind gust. With a first quick speed of around 10°/s, the blades are quickly positioned away from the wind direction to prevent a rotation speed in the generator shaft exceeding the established safety margins. Then, with another, slower, pitch change speed, of around 5°/s, the blades are positioned in the feathered position away from wind thrust.

Document WO05116445, describes a pitch control system that when a wind speed is detected above a given limit, the wind turbine responds positioning the blades away from wind direction and varying the nacelle's azimuthal angle a preset range.

Publication U.S. Pat. No. 4,435,647, refers to a method to reduce the first frequency of a wind turbine's tower oscillations at the same time as maintaining the generator's power constant during wind intensity variations during normal wind turbine operating conditions.

Documents U.S. Pat. No. 6,619,918 and US20040057828, deal with two control systems to keep a safety distance between the wind turbine's blade tip and tower, by means of the instantaneous control of the mechanical loads that affect the blades, deducting the blade tip position and acting on blade yaw with respect to the wind to maintain this safety distance at all times.

The main difference between the applications found in the state-of-the-art and the present invention, lies in this case contemplating an emergency stop during the blade feathering process, when the wind turbine is disconnected from the power-grid by a wind gust: one of the worst assumptions when certifying a wind turbine.

### DESCRIPTION OF THE INVENTION

The objective of the present invention is to protect the wind turbine against loads that generate forces and/or fatigue beyond a desired level on the structure and mechanical components of a wind turbine. It is also designed to find an operating method for an emergency stop in the case of a wind gust affecting the wind turbine combined with it being disconnected from the power-grid.

According to the method in the present invention, the aforementioned criteria are fulfilled in failures that disconnect the wind turbine from the power-grid during a wind gust. This is achieved by firstly reducing the excessive speed the generator rotor reaches to safety margins, and secondly, reducing the vibrations that cause fatigue in the wind turbine's structure and mechanical components during an emergency stop. The latter is achieved with a quick blade feathering, which is controlled at all times, varying the pitch change speed to make the most of the thrust of the wind in the blades so that it offers resistance to tower vibration: in this way the forces and momentum generated on the root of the blades, the first bearing, the base and the top of the tower are minimized.

The method for reducing loads in a wind turbine when the power-grid is disconnected during a wind gust has been developed with the aim of resolving one of the most harmful loads cases for current wind turbine certification, but which is applicable to the rest of normal operating conditions. This obtains a reduction in loads and vibrations of all the wind turbine's components, a reduction in loads for certifying the machine, increasing the fatigue life of all the components not only for certified loads, but also for the rest of real cases. It also reduces tower oscillations, improving its availability and it is possible to optimize both the wind turbine tower and other components, reducing the amount of material used and therefore also lowering costs. The machine's safety margin can also be chosen to be increased instead of changing the design of the elements.

Mexican hat wind gusts are characterized by a slight decrease in the initial wind speed at the start of the phenomenon, followed be a sudden increase in the speed, another quick reduction underneath the initial speed and a recovery to the initial value of the wind speed at the end of the phenomenon. One of the worst assumptions for certifying a wind turbine faced with extreme loads arises when in addition of a Mexican hat wind gust, the wind turbine is also disconnected from the power-grid during this gust. Most of the wind turbine's mechanical components are sized for this event.

### BRIEF DESCRIPTION OF FIGURES

FIG. 1 shows wind profile in the case of a Mexican hat gust, in which power-grid disconnection occurs in the first valley of the gust.

FIG. 2 represents a simplified sketch of a wind turbine and its internal elements, as well as its performance during the action of the wind.

FIG. 3 shows the loads reduction method control sketch.

FIG. 4 itemizes the different strategies superimposed in the evolution of blade rotation in their longitudinal axis during the emergency stop.

### PREFERRED EMBODIMENT OF THE INVENTION

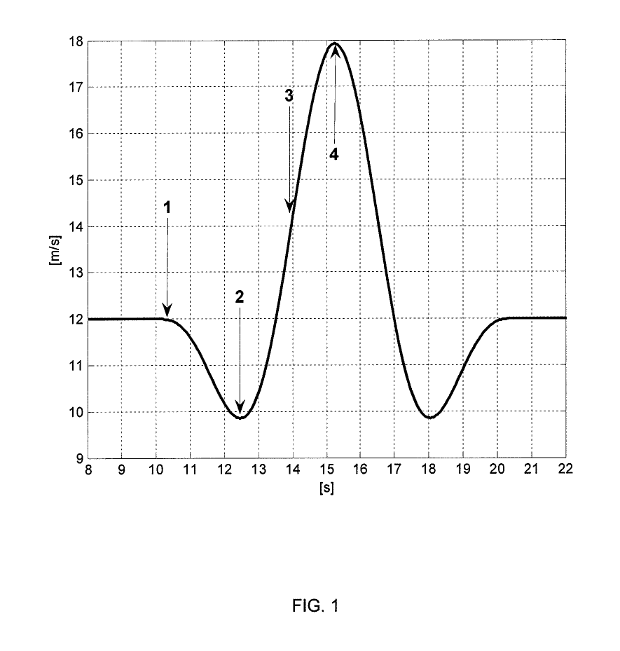

As can be seen in FIG. 1, extreme loads cases where the action of a Mexican hat wind gust is combined with the disconnection of the wind turbine from the power-grid, are defined by the characteristics of the wind gust and the moment when the wind turbine disconnects from the power-grid. A practical case of extreme loads contemplated in IEC standards, refers to a wind gust with an initial speed of 12 m/s followed by wind turbine disconnection which may be at the start of the phenomenon (1), with minimum wind speed (first wind valley) (2), when it accelerates (3), with the gust's maximum wind (4). Likewise, the same wind turbine disconnection points from the power-grid are also considered and defined for a Mexican hat gust but with an initial wind speed of 25 m/s.

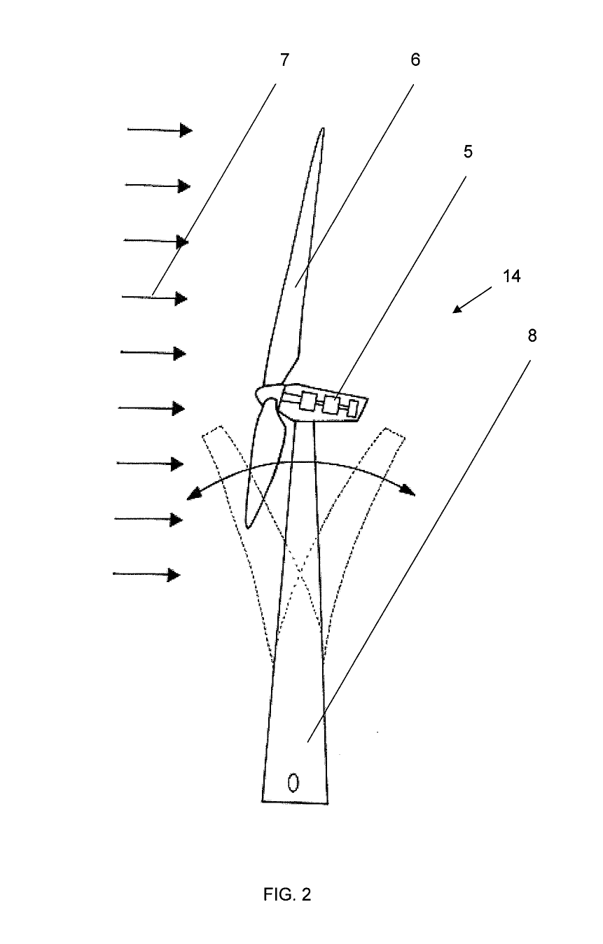

As shown in FIG. 2, the disconnection of a wind turbine (14) from the power-grid or during a power cut, regardless whether the wind gust affects the machine simultaneously or not, signifies a loss of voltage in the generator (5) that, in the event of not quickly positioning the blades (6) to the feathered position, makes the generator rotor (5) suddenly accelerate due to the disappearance of the electric torque that resists rotation. Therefore, wind thrust (7) causes an increase in blade rotation speed (6), which increases loads in the blade's root, in the first bearing, in the tower (8) and that can jeopardize the integrity of the generator itself (5) due to centrifugal force. Likewise, during operation in normal wind turbine conditions (14), the wind (7) affects the surface of the machine's blades facing the wind (6) and they offer resistance to rotation due to the generator's electric torque (5). As a consequence of wind thrust (7) and blade resistance (6), the tower (8) becomes slightly buckled in the same wind direction. If the wind turbine (14) is disconnected from the power-grid at a given moment, this resistance is lost, and the tower (8) may start to swing mainly in its first oscillation mode, and fatigue damage could occur if this phenomenon happens often.

Extreme loads in the wind turbine's mechanical components are even more serious when the disconnection from the power-grid occurs during a wind gust. In this case, the rotor rotation in addition to accelerating due to increased wind speed, also accelerated due to the loss of electric torque that offers resistance to generator rotation, so that the forces and momentum in the base and top of-the tower (8) increase greatly, ditto for the blade root, the blade itself, first bearing and damaged caused by excessive generator speed. Furthermore, the tower's swing can be even worse depending on in which moment of the gust the disconnection occurs, and therefore fatigue damage should be especially taken into account when dimensioning not only the tower but also the rest of the wind turbine's mechanical components (14). Therefore, the present invention proposes a control system to reduce loads in the wind turbine's (14) mechanical components at the same time as reducing the amplitude of the tower's oscillation and allows for optimising the design of its components or increasing the safety margins.

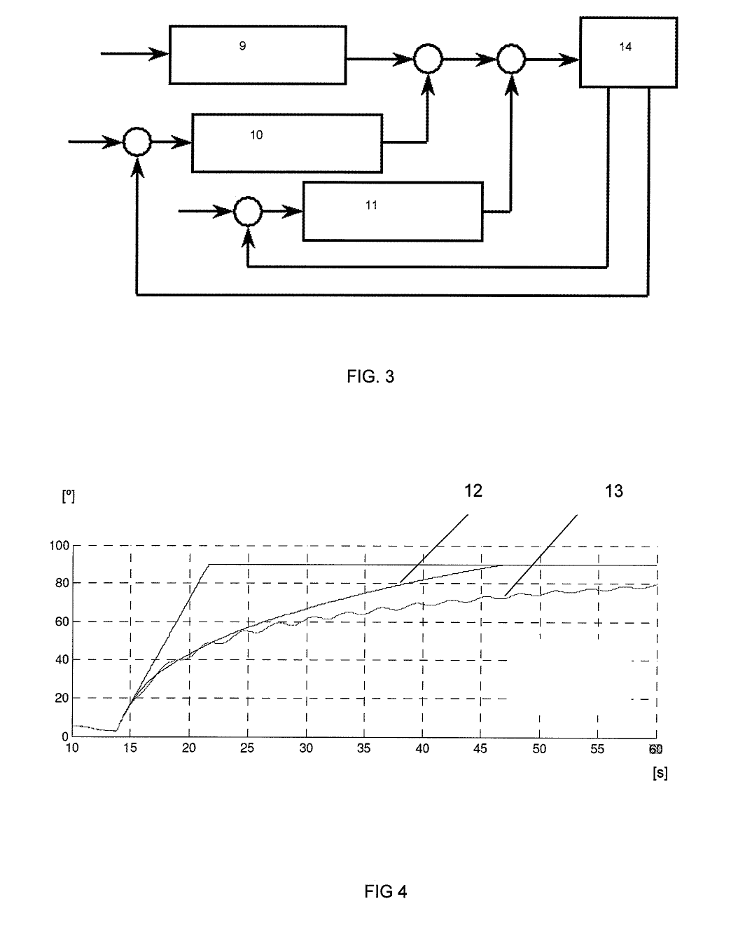

The difficulty for solving this problem mainly lies in, on the one hand, the wind gusts not having linear effects, and on the other, in that it is not possible to predict when the wind turbine (14) will be disconnected from the power-grid in a real case. Therefore, the present invention attempts to tackle these two degrees of freedom with a control system, as shown in FIG. 3, made up of three control loops. The open control loop (9), fixes the operating points that extend the wind turbine's (14) operating range in normal conditions such as the feathering of the blades in emergencies. The other two closed loops (10 and 11) are in charge of incorporating active control strategies to correct and guarantee the optimum point required at each moment of its operation in normal conditions and in blade feathering. This is used to attempt to obtain the main objectives of controlling wind turbine speed, equivalent to preventing extreme values in the force that produces blade rotation, and reducing the maximum bucking values in the base of the tower due to oscillations caused by blade thrust. From a control point of view, the first open loop (9) fixes the values of the system's static response, while the closed loops (10 and 11) improve generator and tower performance updating values dynamically and with non-linear responses.

In this sense, the system's open loop (9) comprises blade yaw control during wind turbine (14) normal operating conditions to adjust the generator rotor's power and rotation, and also includes a controlled stop or feathering process of the blades for emergencies. As can be seen in the curve (12) in FIG. 4, the case of the controlled stop we are talking about according to control in the open loop (9) is defined by starting blade pitch change at high speed and then slowly decelerating until the final feathered position is reached, based on predetermined mean blade pitch change speeds. The risk of exceeding the wind turbine's speed above safety limits is reduced in this way, at the same time as reducing the tower's vibration amplitude from the start of the emergency.

Likewise, as can be seen in curve (13) of FIG. 4, the first closed control loop (10) tries to mitigate tower vibration amplitude at each moment. To do so, it combines a system that predicts the effects of wind gusts and increases the blade yaw angle value before a possible wind turbine (14) disconnection from the power-grid. This system reduces the loads on the tower, together with dynamically and non-linearly varying the speed range at which the wind turbine blades are moved to the feathered position, which counteracts these vibrations in the tower with wind thrust in the blades, based on buckling values in the base of the tower or acceleration at the top of the tower. This strategy superimposes a non-linear curve with a sinusoidal appearance (13) on the first open control loop (12).

And finally, the second closed loop (11) demarcates the curve (13) in FIG. 4 to prevent negative angles of attack, as although the negative lifting coefficients can help to reduce loads and tower oscillation in very special cases, at the same time they also increase generator rotor speed and could cause damage in the gearbox, blades, blade root, and in the first bearing of the wind turbine's main shaft. This closed control loop (11) will bear in mind the parameters on which the angle of attack depends such as rotor speed, wind speed, and blade yaw angle to prevent angles of attack that could cause rotation speeds above the maximum set value for which these components were designed for.

The application of the aforementioned method, shows an improvement in the wind turbine's response compared to the state-of-the-art published to date, regarding minimising wind turbine component loads and vibrations, reducing extreme loads for wind turbine certification, increasing the fatigue life of all the components, not only for certified loads but also for the rest of real cases, reducing oscillation in the tower and consequently improving its availability and making it possible to optimize both the thickness of its walls and the rest of the wind turbine's components, so reducing the amount of material used, and consequently the cost. Or machine safety margins are increased.

1. Method to reduce loads in a wind turbine connected to the power-grid, made up of at least one blade, a variable speed pitch change system, a generator, a tower, a set of sensors laid out on these elements, an uninterruptible power system and a control system connected to these sensors and the pitch change system, characterized by when there is a disconnection from the power-grid during a wind gust, a controlled emergency stop is carried out which includes a quick blade feathering with a progressive reduction of the pitch change speed as the blades reach the feathered position, and a dynamic correction in the form of a sinusoidal wave of the blade pitch change speed during the feathering route.

2. Method to reduce loads in a wind turbine according to claim 1, characterized by the progressive pitch change speed reduction being controlled from an open loop that takes predetermined mean blade pitch change speed values as a reference, and dynamic correction in the form of a sinusoidal wave is introduced from two feedback loops that take tower oscillation and generator speed as a reference respectively.

3. Method to reduce loads in a wind turbine according to claim 2, characterized because the feedback loop that takes tower oscillation as a reference, dynamically accelerates or decelerates blade feathering, so that the aerodynamic effect of pitch change speed variation produces wind thrust on the blades, counteracting tower oscillations during the feathering process.

4. Method to reduce loads in a wind turbine according to claim 3, characterized because the feedback loop that takes generator speed as a reference prevents negative angles of attack in the blades that cause increased generator rotation speed above safety limits.

5. Method for reducing loads in a wind turbine according to claim 1, characterized because the emergency stop is used in any emergency involving power-grid disconnection without the need for it being combined with a wind gust.

6. Method for reducing loads in a wind turbine according to claim 1, characterized because the emergency stop is used in any wind gust, without the need for being combined with a power-grid disconnection.

7. Loads reduction method in a wind turbine according to claim 1, characterized by it comprises the use of any of the three control loops separately or the combination of two of the three control loops.
